(19) United States
(12) Patent Application Publication
(10) Pub. No.: US 2014/0301486 A1
(43) Pub. Date: Oct. 9, 2014

(54) VIDEO QUALITY ASSESSMENT CONSIDERING SCENE CUT ARTIFACTS

(71) Applicants: Ning Liao, Beijing (CN); Zhibo Chen, Beijing (CN); Fan Zhang, Beijing (CN); Kai Xie, Beijing (CN)

(72) Inventors: Ning Liao, Beijing (CN); Zhibo Chen, Beijing (CN); Fan Zhang, Beijing (CN); Kai Xie, Beijing (CN)

(73) Assignee: Thomson Licensing, Issy de Moulineaux (FR)

(21) Appl. No.: 14/355,975

(22) PCT Filed: Nov. 25, 2011
(86) PCT No.: PCT/CN2011/082955

§ 371 Date: May 2, 2014

(51) Int. Cl. H04N 19/86; H04N 19/89; H04N 19/87

(52) U.S. Cl. CPC H04N 19/00909; H04N 19/00921; H04N 19/00939
USPC 375/240.27

(57) ABSTRACT

A particular implementation detects scene cut artifacts in a bitstream without reconstructing the video. A scene cut artifact is usually observed in the decoded video (1) when a scene cut picture in the original video is partially received or (2) when a picture refers to a lost scene cut picture in the original video. To detect scene cut artifacts, candidate scene cut pictures are first selected and scene cut artifact detection is then performed on the candidate pictures. When a block is determined to have a scene cut artifact, a lowest quality level is assigned to the block.

### TECHNICAL FIELD

This invention relates to video quality measurement, and more particularly, to a method and apparatus for determining an objective video quality metric.

### BACKGROUND

With the development of IP networks, video communication over wired and wireless IP networks (for example, IPTV service) has become popular. Unlike traditional video transmission over cable networks, video delivery over IP networks is less reliable. Consequently, in addition to the quality loss from video compression, the video quality is further degraded when a video is transmitted through IP networks. A successful video quality modeling tool needs to rate the quality degradation caused by network transmission impairment (for example, packet losses, transmission delays, and transmission jitters), in addition to quality degradation caused by video compression.

### SUMMARY

According to a general aspect, a bitstream including encoded pictures is accessed, and a scene cut picture in the bitstream is determined using information from the bitstream, without decoding the bitstream to derive pixel information.

According to another general aspect, a bitstream including encoded pictures is accessed, and respective difference measures are determined in response to at least one of frame sizes, prediction residuals, and motion vectors between a set of pictures from the bitstream, wherein the set of pictures includes at least one of a candidate scene cut picture, a picture preceding the candidate scene cut picture, and a picture following the candidate scene cut picture. The candidate scene cut picture is determined to be the scene cut picture if one or more of the difference measures exceed their respective pre-determined thresholds.

According to another general aspect, a bitstream including encoded pictures is accessed. An intra picture is selected as a candidate scene cut picture if compressed data for at least one block in the intra picture are lost, or a picture referring to a lost picture is selected as a candidate scene cut picture. Respective difference measures are determined in response to at least one of frame sizes, prediction residuals, and motion vectors between a set of pictures from the bitstream, wherein the set of pictures includes at least one of the candidate scene cut picture, a picture preceding the candidate scene cut picture, and a picture following the candidate scene cut picture. The candidate scene cut picture is determined to be the scene cut picture if one or more of the difference measures exceed their respective pre-determined thresholds.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1A is a pictorial example depicting a picture with scene cut artifacts at a scene cut frame, FIG. 1B is a pictorial example depicting a picture without scene cut artifacts, and FIG. 1C is a pictorial example depicting a picture with scene cut artifacts at a frame which is not a scene cut frame.

FIGS. 2A and 2B are pictorial examples depicting how scene cut artifacts relate to scene cuts, in accordance with an embodiment of the present principles.

FIG. 3 is a flow diagram depicting an example of video quality modeling, in accordance with an embodiment of the present principles.

FIG. 4 is a flow diagram depicting an example of scene cut artifact detection, in accordance with an embodiment of the present principles.

FIG. 5 is a pictorial example depicting how to calculate the variable nₗₒₛₛ.

FIGS. 6A and 6C are pictorial examples depicting how the variable pk_num varies with the frame index, and FIGS. 6B and 6D are pictorial examples depicting how the variable bytes_num varies with the frame index, in accordance with an embodiment of the present principles.

FIG. 7 is a flow diagram depicting an example of determining candidate scene cut artifact locations, in accordance with an embodiment of the present principles.

FIG. 8 is a pictorial example depicting a picture with 99 macroblocks.

FIGS. 9A and 9B are pictorial examples depicting how neighboring frames are used for scene cut artifact detection, in accordance with an embodiment of the present principles.

FIG. 10 is a flow diagram depicting an example of scene cut detection, in accordance with an embodiment of the present principles.

FIGS. 11A and 11B are pictorial examples depicting how neighboring I-frames are used for artifact detection, in accordance with an embodiment of the present principles.

FIG. 12 is a block diagram depicting an example of a video quality monitor, in accordance with an embodiment of the present principles.

FIG. 13 is a block diagram depicting an example of a video processing system that may be used with one or more implementations.

### DETAILED DESCRIPTION

A video quality measurement tool may operate at different levels. In one embodiment, the tool may take the received bitstream and measure the video quality without reconstructing the video. Such a method is usually referred to as a bitstream level video quality measurement. When extra computational complexity is allowed, the video quality measurement may reconstruct some or all images from the bitstream and use the reconstructed images to more accurately estimate video quality.

The present embodiments relate to objective video quality models that assess the video quality (1) without reconstructing videos; and (2) with partially reconstructed videos. In particular, the present principles consider a particular type of artifacts that is observed around a scene cut, denoted as the scene cut artifact.

Most existing video compression standards, for example, H.264 and MPEG-2, use a macroblock (MB) as the basic encoding unit. Thus, the following embodiments use a macroblock as the basic processing unit. However, the principles may be adapted to use a block at a different size, for example, an 8×8 block, a 16×8 block, a 32×32 block, and a 64×64 block.

When some portions of the coded video bitstream are lost during network transmission, a decoder may adopt error concealment techniques to conceal macroblocks corresponding to the lost portions. The goal of error concealment is to estimate missing macroblocks in order to minimize perceptual quality degradation. The perceived strength of artifacts produced by transmission errors depends heavily on the employed error concealment techniques.

A spatial approach or a temporal approach may be used for error concealment. In a spatial approach, spatial correlation between pixels is exploited, and missing macroblocks are recovered by interpolation techniques from neighboring pixels. In a temporal approach, both the coherence of the motion field and the spatial smoothness of pixels are exploited to estimate motion vectors (MVs) of a lost macroblock or MVs of each lost pixels, then the lost pixels are concealed using the reference pixels in previous frames according to the estimated motion vectors.

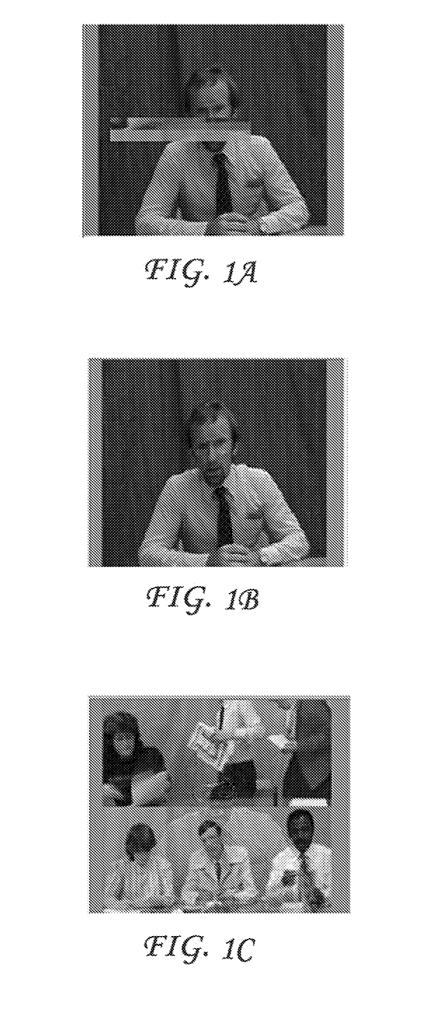

Visual artifacts may still be perceived after error concealment. FIGS. 1A-1C illustrate exemplary decoded pictures, where some packets of the coded bitstream are lost during transmission. In these examples, a temporal error concealment method is used to conceal the lost macroblocks at the decoder. In particular, collocated macroblocks in a previous frame are copied to the lost macroblocks.

In FIG. 1A, packet losses, for example, due to transmission errors, occur at a scene cut frame (i.e., a first frame in a new scene). Because of the dramatic content change between the current frame and the previous frame (from another scene), the concealed picture contains an area that stands out in the concealed picture. That is, this area has very different texture from its neighboring macroblocks. Thus, this area would be easily perceived as a visual artifact. For ease of notation, this type of artifact around a scene cut picture is denoted as a scene cut artifact.

In contrast, FIG. 1B illustrates another picture located within a scene. Since the lost content in the current frames is similar to that in collocated macroblocks in the previous frame, which is used to conceal the current frame, the temporal error concealment works properly and visual artifacts can hardly be perceived in FIG. 1B.

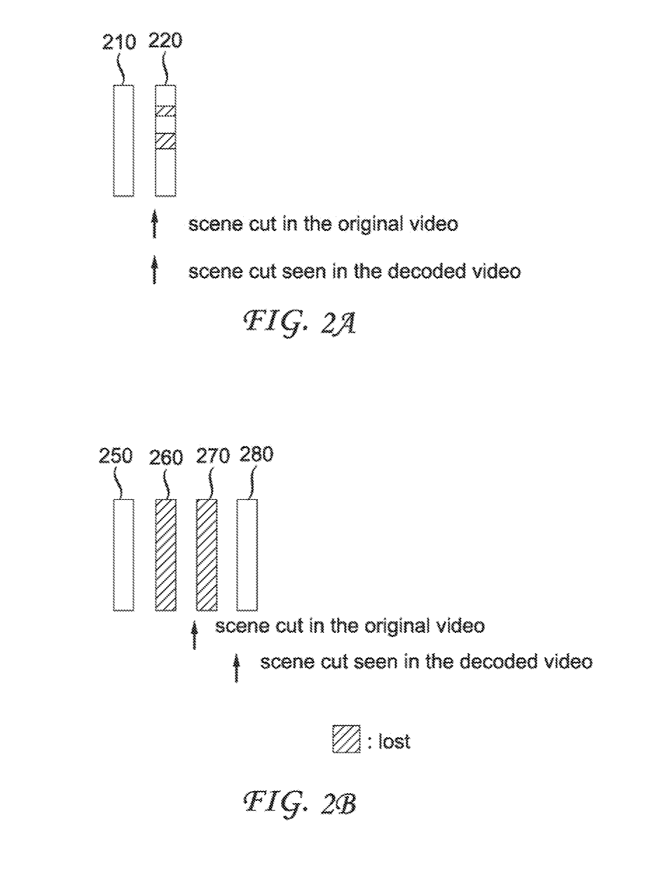

Note that scene cut artifacts may not necessarily occur at the first frame of a scene. Rather, they may be seen at a scene cut frame or after a lost scene cut frame, as illustrated by examples in FIGS. 2A and 2B.

In the example of FIG. 2A, pictures 210 and 220 belong to different scenes. Picture 210 is correctly received, and picture 220 is a partially received scene cut frame. The received parts of picture 220 are properly decoded, where the lost parts are concealed with collocated macroblocks from picture 210. When there is a significant change between pictures 210 and 220, the concealed picture 220 will have scene cut artifacts. Thus, in this example, scene cut artifacts occur at the scene cut frame.

In the example of FIG. 2B, pictures 250 and 260 belong to one scene, and pictures 270 and 280 belong to another scene. During compression, picture 270 is used as a reference for picture 280 for motion compensation. During transmission, the compressed data corresponding to pictures 260 and 270 are lost. To conceal the lost pictures at the decoder, decoded picture 250 may be copied to pictures 260 and 270.

The compressed data for picture 280 are correctly received. But because it refers to picture 270, which is now a copy of decoded picture 250 from another scene, the decoded picture 280 may also have scene cut artifacts. Thus, the scene cut artifacts may occur after a lost scene cut frame (270), in this example, at the second frame of a scene. Note that the scene cut artifacts may also occur in other locations of a scene. An exemplary picture with scene cut artifacts, which occur after a scene cut frame, is described in FIG. 1C.

Indeed, while the scene changes at picture 270 in the original video, the scene may appear to change at picture 280, with scene cut artifacts, in the decoded video. Unless explicitly stated, the scene cuts in the present application refer to those seen in the original video.

In the example shown in FIG. 1A, collocated blocks (i.e., MV=0) in a previous frame are used to conceal lost blocks in the current frame. Other temporal error concealment methods may use blocks with other motion vectors, and may process in different processing units, for example, in a picture level or in a pixel level. Note that scene cut artifacts may occur around the scene cut for any temporal error concealment method.

It can be seen from the examples shown in FIGS. 1A and 1C that scene cut artifacts have a strong negative impact on the perceptual video quality. Thus, to accurately predict objective video quality, it is important to measure the effect of scene cut artifacts when modeling video quality.

To detect scene cut artifacts, we may first need to detect whether a scene cut frame is not correctly received or whether a scene cut picture is lost. This is a difficult problem considering that we may only parse the bitstream (without reconstructing the pictures) when detecting the artifacts. It becomes more difficult when the compression data corresponding to a scene cut frame is lost.

Obviously, the scene cut artifact detection problem for video quality modeling is different from the traditional scene cut frame detection problem, which usually works in a pixel domain and has access to the pictures.

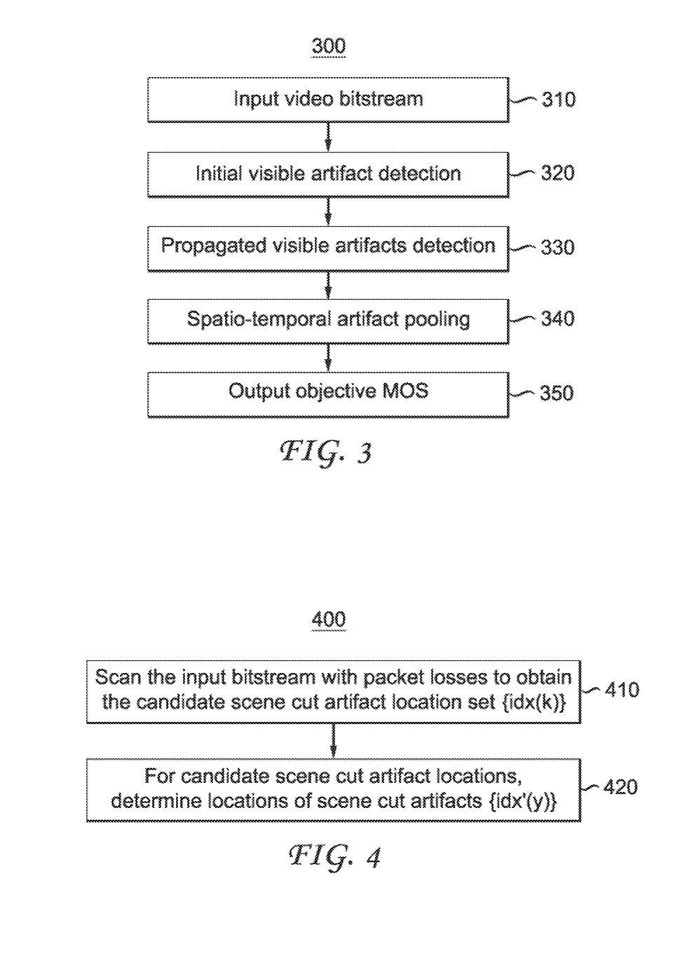

An exemplary video quality modeling method 300 considering scene cut artifacts is shown in FIG. 3. We denote the artifacts resulting from lost data, for example, the one described in FIGS. 1A and 2A, as initial visible artifacts. In addition, we also classify the type of artifacts from the first received picture in a scene, for example, the one described in FIGS. 1C and 2B, as initial visible artifacts.

If a block having initial visible artifacts is used as a reference, for example, for intra prediction or inter prediction, the initial visible artifacts may propagate spatially or temporally to other macroblocks in the same or other pictures through prediction. Such propagated artifacts are denoted as propagated visible artifacts.

In method 300, a video bitstream is input at step 310 and the objective quality of the video corresponding to the bitstream will be estimated. At step 320, an initial visible artifact level is calculated. The initial visible artifact may include the scene cut artifacts and other artifacts. The level of the initial visible artifacts may be estimated from the artifact type, frame type and other frame level or MB level features obtained from the bitstream. In one embodiment, if a scene cut artifact is detected at a macroblock, the initial visible artifact level for the macroblock is set to the highest artifact level (i.e., the lower quality level).

At step 330, a propagated artifact level is calculated. For example, if a macroblock is marked as having a scene cut artifact, the propagated artifact levels of all other pixels referring to this macroblock would also be set to the highest artifact level. At step 340, a spatio-temporal artifact pooling algorithm may be used to convert different types of artifacts into one objective MOS (Mean Opinion Score), which estimates the overall visual quality of the video corresponding to the input bitstream. At step 350, the estimated MOS is output.

FIG. 4 illustrates an exemplary method 400 for scene cut artifact detection. At step 410, it scans the bitstream to determine candidate locations for scene cut artifacts. After candidate locations are determined, it determines whether scene cut artifacts exist in a candidate location at step 420.

Note that step 420 alone may be used for bitstream level scene cut frame detection, for example, in case of no packet loss. This can be used to obtain the scene boundaries, which are needed when scene level features are to be determined. When step 420 is used separately, each frame may be regarded as a candidate scene cut picture, or it can be specified which frames are to be considered as candidate locations.

In the following, the steps of determining candidate scene cut artifact locations and detecting scene cut artifact locations are discussed in further detail.

### Determining Candidate Scene Cut Artifact Locations

As discussed in FIGS. 2A and 2B, scene cut artifacts occur at partially received scene cut frames or at frames referring to lost scene cut frames. Thus, the frames with or surrounding packet losses may be regarded as potential scene cut artifact locations.

In one embodiment, when parsing the bitstream, the numbers of the received packets, the number of lost packets, and the number of received bytes for each frame are obtained based on timestamps, for example, RTP timestamps and MPEG-2 PES timestamps, or the syntax element “frame_num” in the compressed bitstream, and frame types of decoded frames are also recorded. The obtained numbers of packets, number of bytes, and frame types can be used to refine the candidate artifact location determination.

In the following, using RFC3984 for H.264 over RTP as an exemplary transport protocol, we illustrate how to determine candidate scene cut artifact locations.

For each received RTP packet, which video frame it belongs to may be determined based on the timestamp. That is, video packets having the same timestamp are regarded as belonging to the same video frame. For video frame i that is received partially or completely, the following variables are recorded:

(1). the sequence number of the first received RTP packet belonging to frame i, denoted as snₛ(i),

(2). the sequence number of the last received RTP packet for frame i, denoted as snₑ(i), and

(3). the number of lost RTP packets between the first and last received RTP packets for frame i, denoted as nₗₒₛₛ (i).

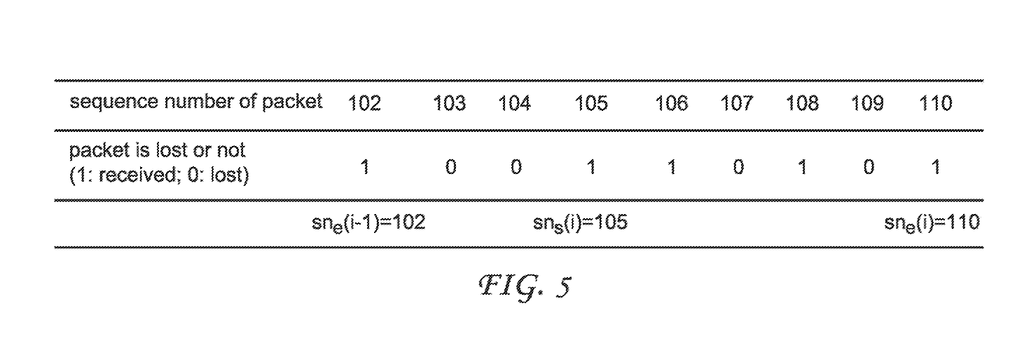

The sequence number is defined in the RTP protocol header and it increments by one per RTP packet. Thus, nₗₒₛₛ (i) is calculated by counting the number of lost RTP packets whose sequence numbers are between snₛ(i) and snₑ(i) based on the discontinuity of sequence numbers. An example of calculating nₗₒₛₛ (i) is illustrated in FIG. 5. In this example, snₛ(i)=105 and snₑ(i)=110. Between the starting packet (with a sequence number 105) and ending packet (with a sequence number 110) for frame i, packets with sequence numbers 107 and 109 are lost. Thus, nₗₒₛₛ (i)=2 in this example.

A parameter, pk_num(i), is defined to estimate the number of packets transmitted for frame i and it may be calculated as

pk_num(i)=[snₑ(i)−snₑ(i−k)]/k, (1)

where frame i-k is the frame immediately before frame i (i.e., other frames between frames i and i-k are lost). For frame i having packet losses or having immediately preceding frame(s) lost, we calculate a parameter, pk_num_avg(i), by averaging pk_num of the previous (non-I) frames in a sliding window of length N (for example, N=6), that is, pk_num_avg(i) is defined as the average (estimated) number of transmitted packets preceding the current frame:

$${pk}_{{num}_{acg ( i )}} = \frac{1}{N} {\sum }_{j} {pk}_{num ( j )} , \\ frame j ∈ the sliding window . \qquad ( 2 )$$

In addition, the average number of bytes per packet (bytes_num_{packet}(i)) may be calculated by averaging the numbers of bytes in the received packets of immediately previous frames in a sliding window of N frames. A parameter, bytes_num(i), is defined to estimate the number of bytes transmitted for frame i and it may be calculated as:

bytes_num(i)=bytes_{recvd}(i)+[nₗₒₛₛ(i)+snₛ(i)−snₑ(i−k)−1]*bytes_num_{packet}(i)/k, (3)

where bytes_{recvd}(i) is the number of bytes received for frame i, and [nₗₒₛₛ (i)+snₛ(i)−snₑ(i−k)−1]*bytes_num_{packet}(i)/k is the estimated number of lost bytes for frame i. Note that Eq. (3) is designed particularly for the RTP protocol. When other transport protocols are used, Eq. (3) should be adjusted, for example, by adjusting the estimated number of lost packets.

A parameter, bytes_num_avg(i), is defined as the average (estimated) number of transmitted bytes preceding the current frame, and it can be calculated by averaging bytes_num of the previous (non-I) frames in a sliding window, that is,

$${bytes}_{{num}_{avg ( i )}} = \frac{1}{N} {\sum }_{j} {bytes}_{num ( j )} , \\ frame j ∈ the sliding window . \qquad ( 4 )$$

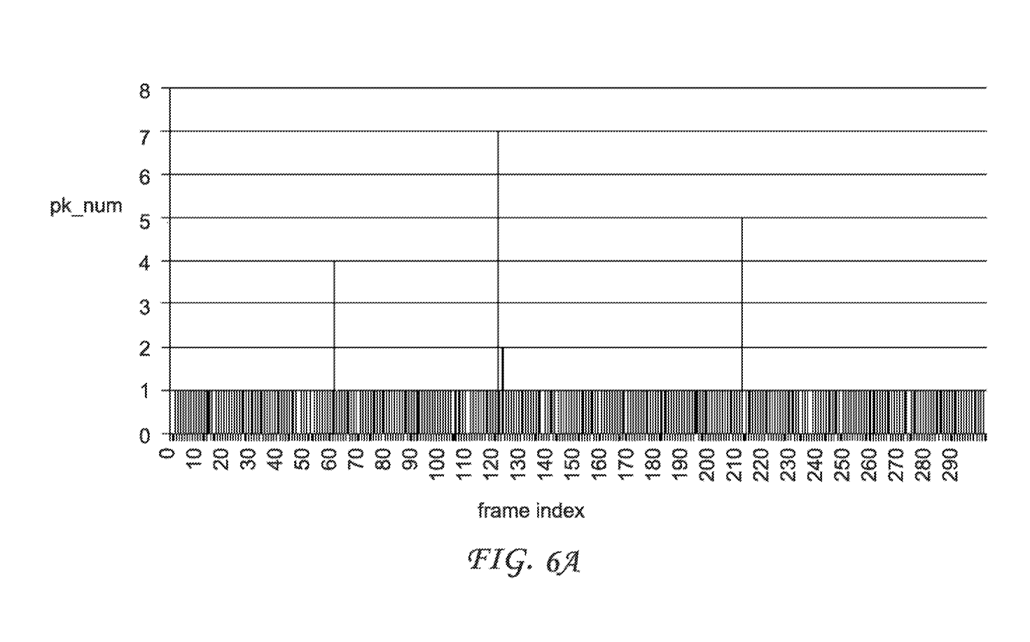

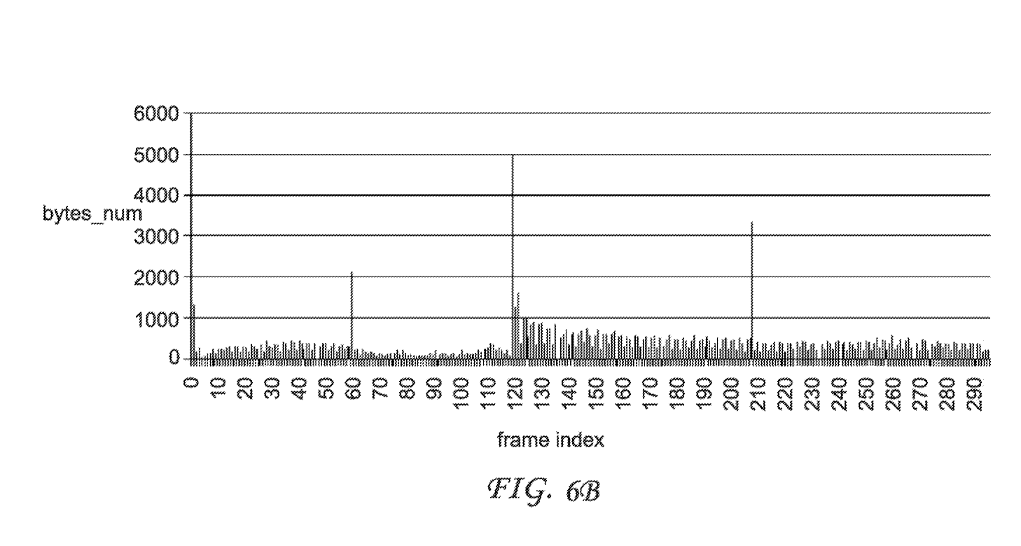

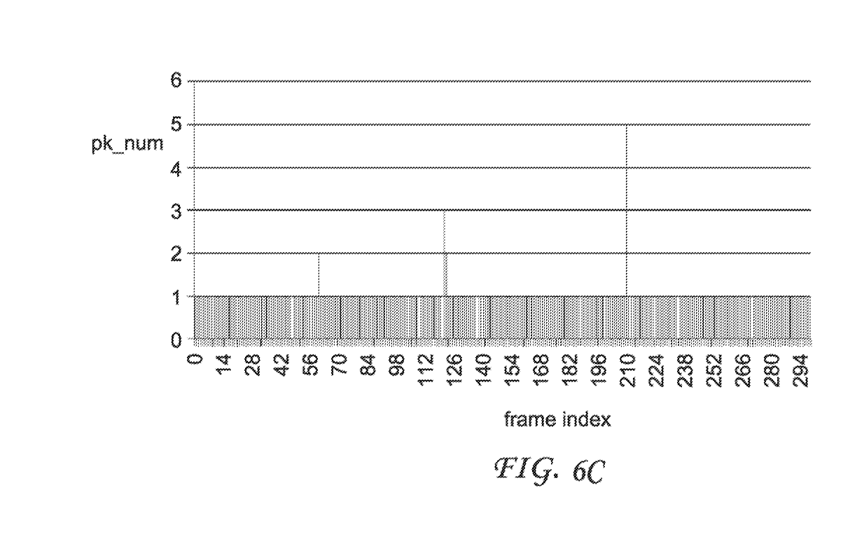

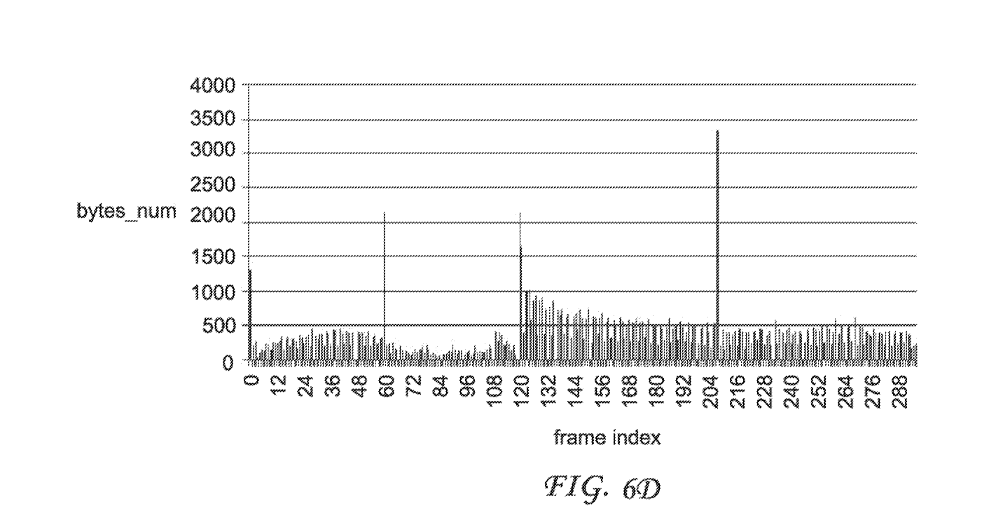

As discussed above, a sliding window can be used for calculating pk_num_avg, bytes_num_{packet}, and bytes_num_avg. Note that the pictures contained in the sliding window are completely or partially received (i.e., they are not lost completely). When the pictures in a video sequence generally have the same spatial resolution, pk_num for a frame highly depends on the picture content and frame type used for compression. For example, a P-frame of a QCIF video may correspond to one packet, and an I-frame may need more bits and thus corresponds to more packets, as illustrated in FIG. 6A.

As shown in FIG. 2A, scene cut artifacts may occur at a partially received scene cut frame. Since a scene cut frame is usually encoded as an I-frame, a partially received I-frame may be marked as a candidate location for scene cut artifacts, and its frame index is recorded as idx(k), where k indicates that the frame is a k^{th} candidate location.

A scene cut frame may also be encoded as a non-intra (for example, a Pframe). Scene cut artifacts may also occur in such a frame when it is partially received. A frame may also contain scene cut artifacts if it refers to a lost scene cut frame, as discussed in FIG. 2B. In these scenarios, the parameters discussed above may be used to more accurately determine whether a frame should be a candidate location.

FIGS. 6A-6D illustrate by examples how to use the above-discussed parameters to identify candidate scene cut artifact locations. The frames may be ordered in a decoding order or a display order. In all examples of FIGS. 6A-6D, frames 60 and 120 are scene cut frames in the original video.

In examples of FIGS. 6A and 6B, frames 47, 109, 137, 235, and 271 are completely lost, and frames 120 and 210 are partially received. For frames 49, 110, 138, 236, 272, 120, and 210, pk_num(i) may be compared with pk_num_avg(i). When pk_num(i) is much larger than pk_num_avg(i), for example, 3, frame i may be identified as a candidate scene cut frame in the decoded video. In the example of FIG. 6A, frame 120 is identified as a candidate scene cut artifact location.

The comparison can also be done between bytes_num(i) and bytes_num_avg(i). If bytes_num(i) is much larger than bytes_num_avg(i), frame i may be identified as a candidate scene cut frame in the decoded video. In the example of FIG. 6B, frame 120 is again identified as a candidate location.

In examples of FIGS. 6C and 6D, scene cut frame 120 is completely lost. For its following frame 121, pk_num(i) may be compared with pk_num_avg(i). In the example of FIG. 6C, 3. Thus, frame 120 is not identified as a candidate scene cut artifact location. In contrast, when comparing bytes_num(i) with bytes_num_avg(i), 3, and frame 120 is identified as a candidate location.

In general, the method using the estimated number of transmitted bytes is observed to have better performance than the method using the estimated number of transmitted packets.

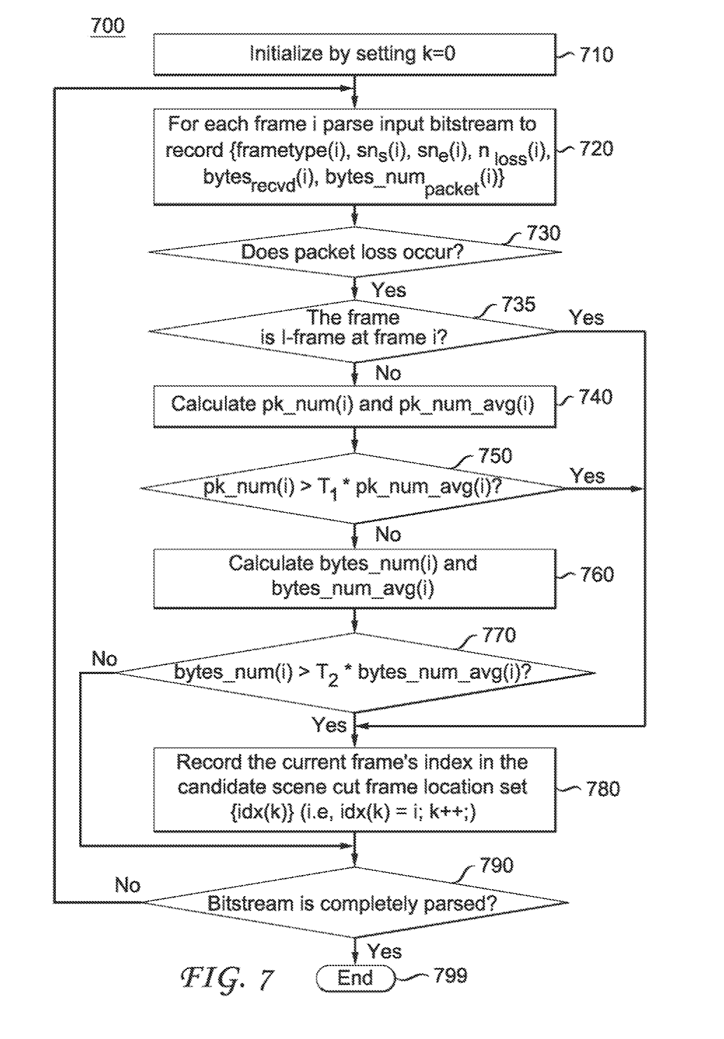

FIG. 7 illustrates an exemplary method 700 for determining candidate scene cut artifact locations, which will be recorded in a data set denoted by {idx(k)}. At step 710, it initializes the process by setting k=0. The input bitstream is then parsed at step 720 to obtain the frame type and the variable snₛ, snₑ, nₗₒₛₛ, bytes_num_{packet}, and bytes_{recvd} for a current frame.

It determines whether there is a packet loss at step 730. When a frame is completely lost, its closest following frame, which is not completely lost, is examined to determine whether it is a candidate scene cut artifact location. When a frame is partially received (i.e., some, but not all, packets of the frame are lost), this frame is examined to determine whether it is a candidate scene cut artifact location.

If there is a packet loss, it checks whether the current frame is an INTRA frame. If the current frame is an INTRA frame, the current frame is regarded as a candidate scene cut location and the control is passed to step 780. Otherwise, it calculates pk_num and pk_num_avg, for example, as described in Eqs. (1) and (2), at step 740. It checks whether pk_num>T₁*pk_num_avg at step 750. If the inequality holds, the current frame is regarded as a candidate frame for scene cut artifacts and the control is passed to step 780.

Otherwise, it calculates bytes_num and bytes_num_avg, for example, as described in Eqs. (3) and (4), at step 760. It checks whether bytes_num>T₂*bytes_num_avg at step 770. If the inequality holds, the current frame is regarded as a candidate frame for scene cut artifacts, and the current frame index is recorded as idx(k) and k is incremented by one at step 780. Otherwise, it passes control to step 790, which checks whether the bitstream is completely parsed. If parsing is completed, control is passed to an end step 799. Otherwise, control is returned to step 720.

In FIG. 7, both the estimated number of transmitted packets and the estimated number of transmitted bytes are used to determine candidate locations. In other implementation, these two methods can be examined in another order or can be applied separately.

### Detecting Scene Cut Artifact Locations

Scene cut artifacts can be detected after candidate location set {idx(k)} is determined. The present embodiments use the packet layer information (such as the frame size) and the bitstream information (such as prediction residuals and motion vectors) in scene cut artifacts detection. The scene cut artifact detection can be performed without reconstructing the video, that is, without reconstructing the pixel information of the video. Note that the bitstream may be partially decoded to obtain information about the video, for example, prediction residuals and motion vectors.

When the frame size is used to detect scene cut artifact locations, a difference between the numbers of bytes of the received (partial or completely) P-frames before and after a candidate scene cut position is calculated. If the difference exceeds a threshold, for example, three times larger or smaller, the candidate scene cut frame is determined as a scene cut frame.

On the other hand, we observe that the prediction residual energy change is often greater when there is a scene change. Generally, the prediction residual energy of P-frame and B-frame is not at the same order of magnitude, and the prediction residual energy of B-frame is less reliable to indicate video content information than that of P-frame. Thus, we prefer using the residual energy of P-frames.

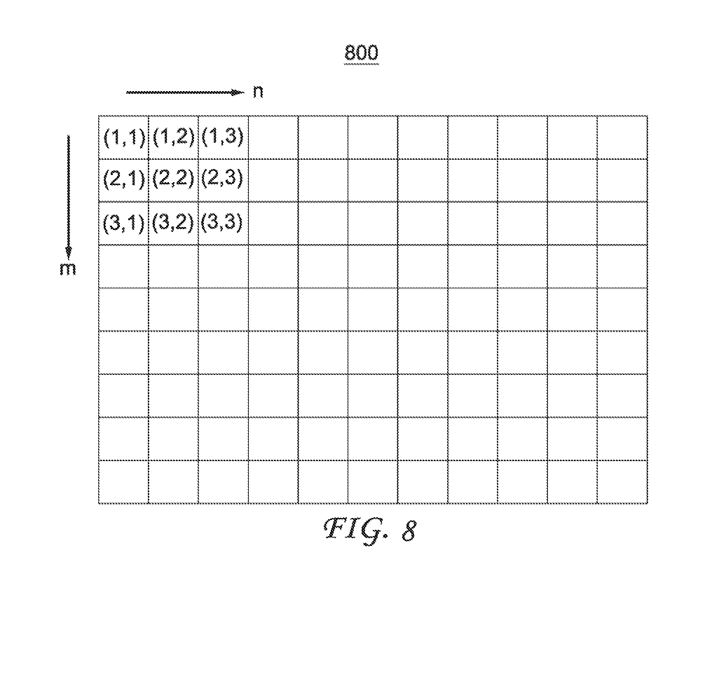

Referring to FIG. 8, an exemplary picture 800 containing 11*9=99 macroblocks is illustrated. For each macroblock indicated by its location (m, n), a residual energy factor is calculated from the de-quantized transform coefficients. In one embodiment, the residual energy factor is calculated as

$${e}_{m , n} = {\sum }_{p = 1}^{16} {\sum }_{q = 1}^{16} {X}_{p , q}^{2} ( m , n ) ,$$

where X_{p,q}(m,n) is the de-quantized transform coefficient at location (p,q) within macroblock (m, n). In another embodiment, only AC coefficients are used to calculate the residual energy factor, that is,

$${e}_{m , n} = {\sum }_{p = 1}^{16} {\sum }_{q = 1}^{16} {X}_{p , q}^{2} ( m , n ) - {X}_{1 , 1}^{2} ( m , n ) .$$

In another embodiment, when 4×4 transform is used, the residual energy factor may be calculated as

$${e}_{m , n} = {\sum }_{u = 1}^{16} ( {\sum }_{v = 2}^{16} {X}_{u , v}^{2} ( m , n ) + α {X}_{u , 1}^{2} ( m , n ) ) ,$$

where X_{u,1}(m,n) represents the DC coefficient and X_{u,v}(m,n) (v=2, . . . , 16) represent the AC coefficients for the u^{th} 4×4 block, and α is a weighting factor for the DC coefficients. Note there are sixteen 4×4 blocks in a 16×16 macroblock and sixteen transform coefficients in each 4×4 block. The prediction residual energy factors for a picture can then be represented by a matrix:

$$E = [ \begin{matrix}{e}_{1 , 1} & {e}_{1 , 2} & {e}_{1 , 3} & … \\ {e}_{2 , 1} & {e}_{2 , 2} & {e}_{2 , 3} & … \\ {e}_{3 , 1} & {e}_{3 , 2} & {e}_{3 , 3} & … \\ & … & … & \end{matrix} ] .$$

When other coding units instead of a macroblock are used, the calculation of the prediction residual energy can be easily adapted.

A difference measure matrix for the k^{th} candidate frame location may be represented by:

$$Δ {E}_{k} = [ \begin{matrix}Δ {e}_{1 , 1 , k} & Δ {e}_{1 , 2 , k} & Δ {e}_{1 , 3 , k} & … \\ Δ {e}_{2 , 1 , k} & Δ {e}_{2 , 2 , k} & Δ {e}_{2 , 3 , k} & … \\ Δ {e}_{3 , 1 , k} & Δ {e}_{3 , 2 , k} & Δ {e}_{3 , 3 , k} & … \\ & … & … & \end{matrix} ] ,$$

where Δe_{m, n, k} is the difference measure calculated for the k^{th} candidate location at macroblock (m,n). Summing up the difference over all macroblocks in a frame, a difference measure for the candidate frame location can be calculated as

$${D}_{k} = {\sum }_{m} {\sum }_{n} Δ {e}_{m , n , k} .$$

We may also use a subset of the macroblocks for calculating Dₖ to speed up the computation. For example, we may use every other row of macroblocks or every other column of macroblocks for calculation.

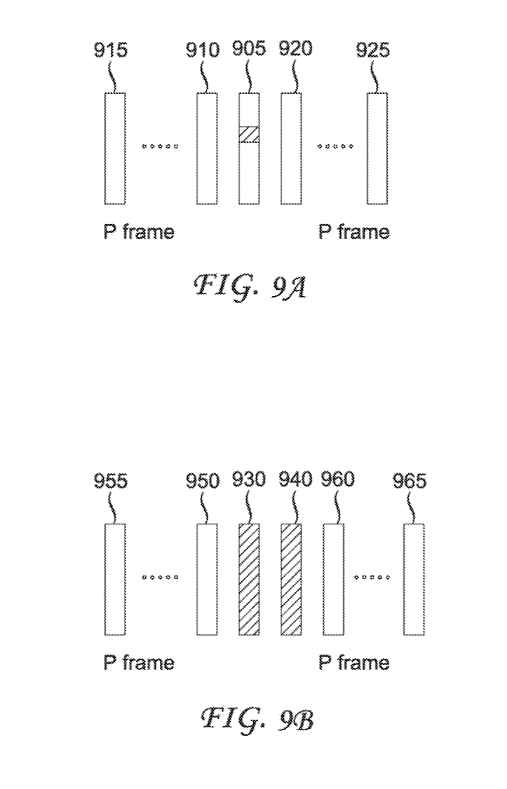

In one embodiment, Δe_{m, n, k} may be calculated as a difference between two P-frames closest to the candidate location: one immediately before the candidate location and the other immediate after it. Referring to FIGS. 9A and 9B, pictures 910 and 920, or pictures 950 and 960, may be used to calculate Δe_{m, n, k} by applying a subtraction between prediction residual energy factors at macroblock (m,n) at both pictures.

The parameter Δe_{m, n, k} can also be calculated by applying a difference of Gaussion (DoG) filter to more pictures, for example, a 10-point DoG filter may be used with the center of the filter located at a candidate scene cut artifact location. Referring back FIGS. 9A and 9B, pictures 910-915 and 920-925 in FIG. 9A, or pictures 950-955 and 960-965 in FIG. 9B may be used. For each macroblock location (m,n), a difference of Gaussian filtering function is applied to e_{m, n} of a window of frames to obtain the parameter Δe_{m, n, k}.

When the difference calculated using the prediction residual energy exceeds a threshold, the candidate frame may be detected as having scene cut artifacts.

Motion vectors can also be used for scene cut artifact detection. For example, the average magnitude of the motion vectors, the variance of the motion vectors, and the histogram of motion vectors within a window of frames may be calculated to indicate the level of motion. Motion vectors of P-frames are preferred for scene cut artifact detection. If the difference of the motion levels exceeds a threshold, the candidate scene cut position may be determined as a scene cut frame.

Using the features such as the frame size, prediction residual energy, and motion vector, a scene cut frame may be detected at the decoded video at a candidate location. If the scene change is detected in the decoded video, the candidate location is detected as having scene cut artifacts. More particularly, the lost macroblocks of the detected scene cut frame are marked as having scene cut artifacts if the candidate location corresponds to a partially lost scene cut frame, and the macroblocks referring to a lost scene cut frame are marked as having scene cut artifacts if the candidate location corresponds to a P- or B-frame referring to a lost scene cut frame.

Note that the scene cuts at the original video may or may not overlap with those seen at the decoded video. As discussed before, for the example shown in FIG. 2B, a scene change is observed at picture 280 at the decoded video while the scene changes at picture 270 in the original video.

The frames at and around the candidate locations may be used to calculate the frame size change, the prediction residual energy change, and motion change, as illustrated in the examples of FIGS. 9A and 9B. When a candidate location corresponds to a partially received scene cut frame 905, the P-frames (910 . . . 915, and 920 . . . 925) surrounding the candidate location may be used. When a candidate location corresponds to a frame referring to a lost scene cut frame 940, the P-frames (950, . . . 955, and 960, . . . 965) surrounding the lost frame can be used. When a candidate location corresponds to a P-frame, the candidate location itself (960) may be used for calculating prediction residual energy difference. Note that different numbers of pictures may be used for calculating the changes in frame sizes, prediction residuals, and motion levels.

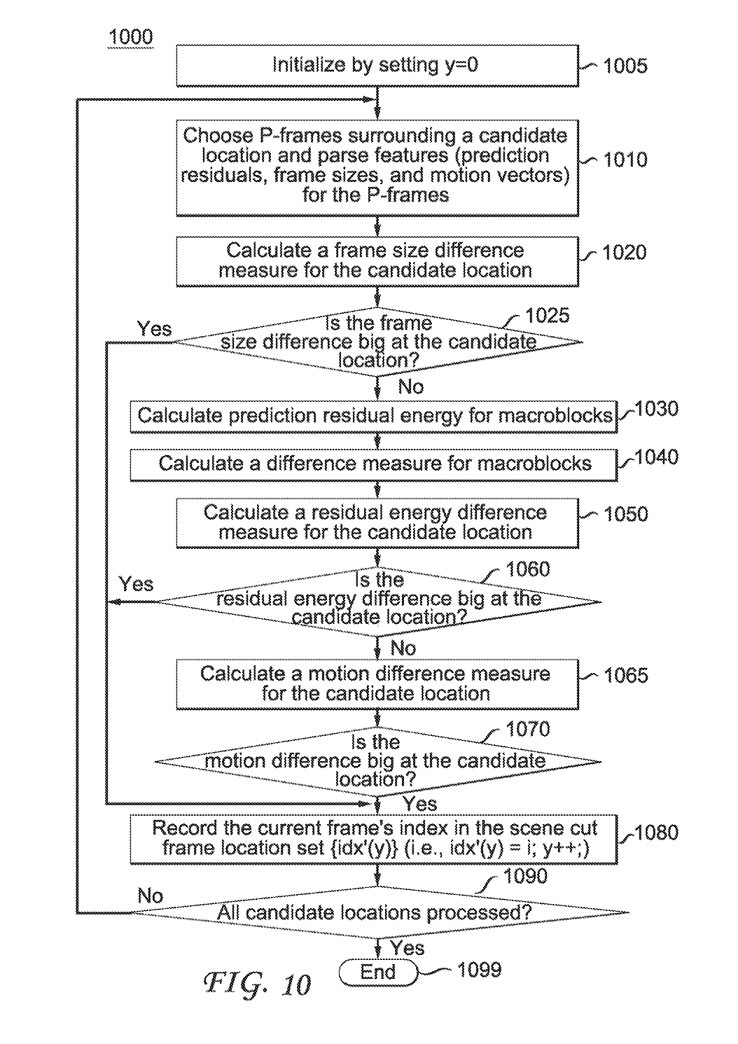

FIG. 10 illustrates an exemplary method 1000 for detecting scene cut frames from candidate locations. At step 1005, it initializes the process by setting y=0. P-frames around a candidate location are selected and the prediction residuals, frame sizes, and motion vectors are parsed at step 1010.

At step 1020, it calculates a frame size difference measure for the candidate frame location. At step 1025, it checks whether there is a big frame size change at the candidate location, such as by comparing it with a threshold. If the difference is less than a threshold, it passes control to step 1030.

Otherwise, for those P-frames selected at step 1010, a prediction residual energy factor is calculated for individual macroblocks at step 1030. Then at step 1040, a difference measure is calculated for individual macroblock locations to indicate the change in prediction residual energy, and a prediction residual energy difference measure for the candidate frame location can be calculated at step 1050. At step 1060, it checks whether there is a big prediction residual energy change at the candidate location. In one embodiment, if Dₖ is large, for example, Dₖ>T₃, where T₃ is a threshold, then the candidate location is detected as a scene cut frame in the decoded video and it passes control to step 1080.

Otherwise, it calculates a motion difference measure for the candidate location at step 1065. At step 1070, it checks whether there is a big motion change at the candidate location. If there is a big difference, it passes control to step 1080.

At step 1080, the corresponding frame index is recorded as {idx′(y)} and y is incremented by one, where y indicates that the frame is a y^{th} detected scene cut frame in the decoded video. It determines whether all candidate locations are processed at 1090. If all candidate locations are processed, control is passed to an end step 1099. Otherwise, control is returned to step 1010.

In another embodiment, when the candidate scene cut frame is an I-frame (735), the prediction residual energy difference between the picture and a preceding I-frame is calculated. The prediction residual energy difference is calculated using the energy of the correctly received MBs in the picture and the collocated MBs in the preceding I-frame. If the difference between the energy factors is T₄ times larger than the larger energy factor (e.g., T₄=⅓), the candidate I-frame is detected as a scene cut frame in the decoded video. This is useful when scene cut artifacts of the candidate scene cut frame needs to be determined before the decoder proceeds to the decoding of next picture, that is, the information of the following pictures is not yet available at the time of artifacts detection.

Note that the features can be considered in different orders. For example, we may learn the effectiveness of each feature through training a large set of video sequences at various coding/transmission conditions. Based on the training results, we may choose the order of the features based on the video content and coding/transmission conditions. We may also decide to only test one or two most effective features to speed up the scene cut artifact detection.

Various thresholds, for example, T₁, T₂, T₃, and T₄, are used in methods 900 and 1000. These thresholds may be adaptive, for example, to the picture properties or other conditions.

In another embodiment, when additional computational complexity is allowed, some I-pictures will be reconstructed. Generally, pixel information can better reflect texture content than parameters parsed from the bitstream (for example, prediction residuals, and motion vectors), and thus, using reconstructed I-pictures for scene cut detection can improve the detection accuracy. Since decoding I-frame is not as computationally expensive as decoding P- or B-frames, this improved detection accuracy comes at a cost of a small computational overhead.

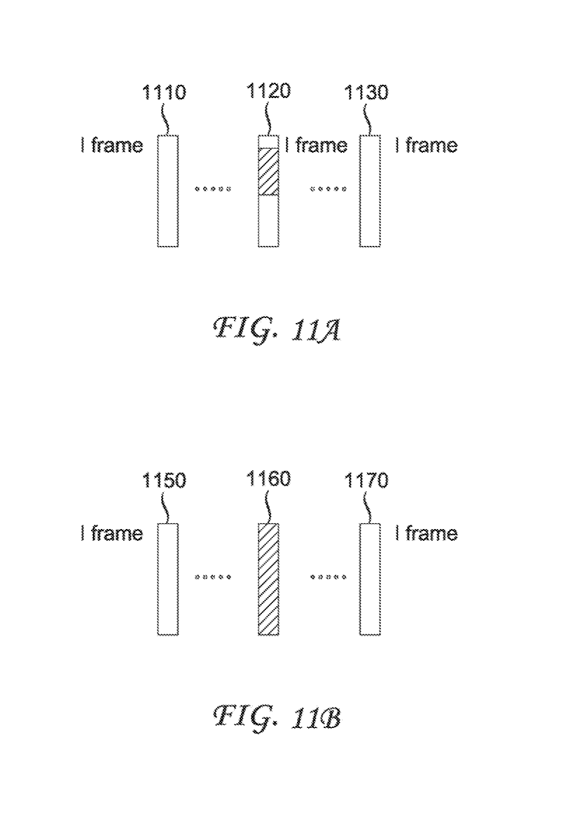

FIG. 11 illustrates by an example how adjacent I-frames can be used for scene cut detection. For the example shown in FIG. 11A, when the candidate scene cut frame (1120) is a partially received I-frame, the received part of the frame can be decoded properly into the pixel domain since it does not refer to other frames. Similarly, adjacent I-frames (1110, 1130) can also be decoded into the pixel domain (i.e., the pictures are reconstructed) without incurring much decoding complexity. After the I-frames are reconstructed, the traditional scene cut detection methods may be applied, for example, by comparing the difference of the histogram of luminance between the partially decoded pixels of frame (1120) and the collocated pixels of adjacent I-frames (1110, 1130).

For the example shown in FIG. 11B, the candidate scene cut frame (1160) may be totally lost. In this case, if the image feature difference (for example, histogram difference) between adjacent I-frames (1150, 1170) is small, the candidate location can be identified as a not being a scene cut location. This is especially true in the IPTV scenario where the GOP length is usually 0.5 or 1 second, during which multiple scene changes are unlikely.

Using reconstructed I-frames for scene cut artifacts detection may have limited use when the distance between I-frames is large. For example, in mobile video stream scenario, the GOP length can be up 5 seconds, and the frame rate can be as low as 15 fps. Therefore, the distance between the candidate scene cut location and the previous I-frame is too large to obtain robust detection performance.

The embodiment which decodes some I-pictures may be used in combination with the bitstream level embodiment (for example, method 1000) to complement each other. In one embodiment, when they should be deployed together may be decided from the encoding configuration (for example, resolution, frame rates).

The present principles may be used in a video quality monitor to measure video quality. For example, the video quality monitor may detect and measure scene cut artifacts and other types of artifacts, and it may also consider the artifacts caused by propagation to provide an overall quality metric.

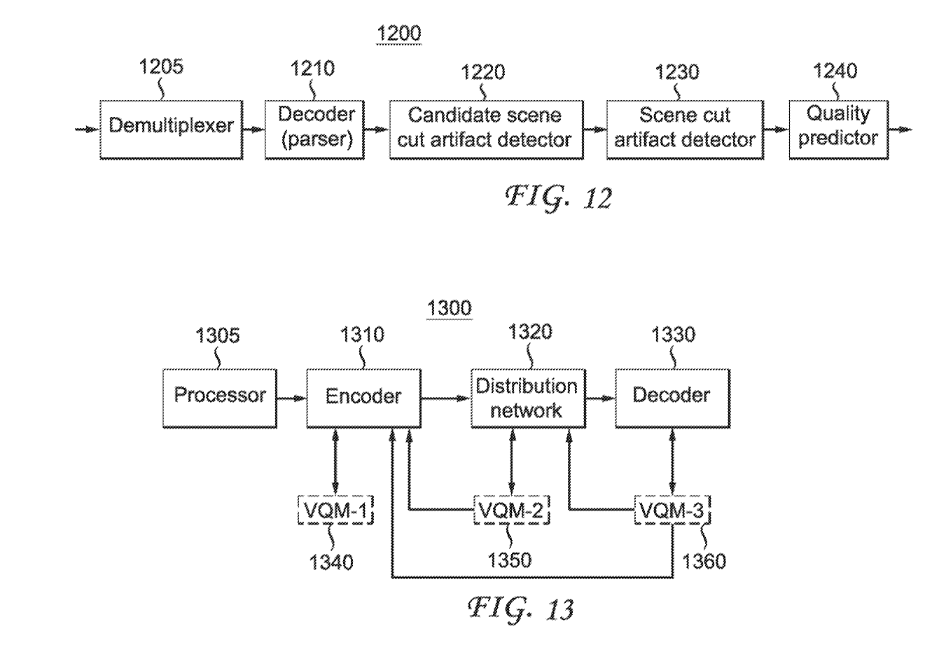

FIG. 12 depicts a block diagram of an exemplary video quality monitor 1200. The input of apparatus 1200 may include a transport stream that contains the bitstream. The input may be in other formats that contains the bitstream.

Demultiplexer 1205 obtains packet layer information, for example, number of packets, number of bytes, frame sizes, from the bitstream. Decoder 1210 parses the input stream to obtain more information, for example, frame type, prediction residuals, and motion vectors. Decoder 1210 may or may not reconstruct the pictures. In other embodiments, the decoder may perform the functions of the demultiplexer.

Using the decoded information, candidate scene cut artifact locations are detected in a candidate scene cut artifact detector 1220, wherein method 700 may be used. For the detected candidate locations, a scene cut artifact detector 1230 determines whether there are scene cuts in the decoded video, therefore determines whether the candidate locations contain scene cut artifacts. For example, when the detected scene cut frame is a partially lost I-frame, a lost macroblock in the frame is detected as having a scene cut artifact. In another example, when the detected scene cut frame refers to a lost scene cut frame, a macroblock that refers to the lost scene cut frame is detected as having a scene cut artifact. Method 1000 may be used by the scene cut detector 1230.

After the scene cut artifacts are detected in a macroblock level, a quality predictor 1240 maps the artifacts into a quality score. The quality predictor 1240 may consider other types of artifacts, and it may also consider the artifacts caused by error propagation.

Referring to FIG. 13, a video transmission system or apparatus 1300 is shown, to which the features and principles described above may be applied. A processor 1305 processes the video and the encoder 1310 encodes the video. The bitstream generated from the encoder is transmitted to a decoder 1330 through a distribution network 1320. A video quality monitor may be used at different stages.

In one embodiment, a video quality monitor 1340 may be used by a content creator. For example, the estimated video quality may be used by an encoder in deciding encoding parameters, such as mode decision or bit rate allocation. In another example, after the video is encoded, the content creator uses the video quality monitor to monitor the quality of encoded video. If the quality metric does not meet a pre-defined quality level, the content creator may choose to re-encode the video to improve the video quality. The content creator may also rank the encoded video based on the quality and charges the content accordingly.

In another embodiment, a video quality monitor 1350 may be used by a content distributor. A video quality monitor may be placed in the distribution network. The video quality monitor calculates the quality metrics and reports them to the content distributor. Based on the feedback from the video quality monitor, a content distributor may improve its service by adjusting bandwidth allocation and access control.

The content distributor may also send the feedback to the content creator to adjust encoding. Note that improving encoding quality at the encoder may not necessarily improve the quality at the decoder side since a high quality encoded video usually requires more bandwidth and leaves less bandwidth for transmission protection. Thus, to reach an optimal quality at the decoder, a balance between the encoding bitrate and the bandwidth for channel protection should be considered.

In another embodiment, a video quality monitor 1360 may be used by a user device. For example, when a user device searches videos in Internet, a search result may return many videos or many links to videos corresponding to the requested video content. The videos in the search results may have different quality levels. A video quality monitor can calculate quality metrics for these videos and decide to select which video to store. In another example, the user may have access to several error concealment techniques. A video quality monitor can calculate quality metrics for different error concealment techniques and automatically choose which concealment technique to use based on the calculated quality metrics.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, scene cut artifact detection, quality measuring, and quality monitoring. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, a game console, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method, comprising:
accessing a bitstream including encoded pictures; and
determining a scene cut artifact in the bitstream using information from the bitstream without decoding the bitstream to derive pixel information.

2. The method of claim 1, wherein the determining comprises:
determining respective difference measures in response to at least one of frame sizes, prediction residuals, and motion vectors between a set of pictures from the bitstream, wherein the set of pictures includes at least one of a candidate scene cut picture, a picture preceding the candidate scene cut picture, and a picture following the candidate scene cut picture; and
determining that the candidate scene cut picture is a picture with the scene cut artifact if one or more of the difference measures exceed their respective pre-determined thresholds.

3. The method of claim 2, the determining the respective difference measures further comprising:
calculating prediction residual energy factors corresponding to a block location for pictures of the set of pictures; and
computing a difference measure for the block location using the prediction residual energy factors, wherein the difference measure for the block location is used to compute the difference measure for the candidate scene cut picture.

4. The method of claim 2, further comprising at least one of:
selecting an intra picture as the candidate scene cut picture if compressed data for at least one block in the intra picture are lost; and
selecting a picture referring to a lost picture as the candidate scene cut picture.

5. The method of claim 4, further comprising:
determining that the at least one block in the candidate scene cut picture has the scene cut artifact.

6. The method of claim 5, further comprising:
assigning a lowest quality level to the at least one block that is determined to have the scene cut artifact.

7. (canceled)

8. The method of claim 4, further comprising:
determining an estimated number of transmitted packets of a picture and an average number of transmitted packets of pictures preceding the picture, wherein the picture is selected as the candidate scene cut picture when a ratio between the estimated number of transmitted packets of the picture and the average number of transmitted packets of pictures preceding the picture exceeds a pre-determined threshold.

9. The method of claim 4, further comprising:
determining an estimated number of transmitted bytes of a picture and an average number of transmitted bytes of pictures preceding the picture, wherein the picture is selected as the candidate scene cut picture when a ratio between the estimated number of transmitted bytes of the picture and the average number of transmitted bytes of pictures preceding the picture exceeds a pre-determined threshold.

10. The method of claim 9, wherein the estimated number of transmitted bytes of the picture is determined in response to a number of received bytes of the picture and an estimated number of lost bytes.

11. The method of claim 4, further comprising:
determining that a block in the candidate scene cut picture has the scene cut artifact when the block refers to the lost picture.

12-13. (canceled)

14. An apparatus, comprising:
a decoder accessing a bitstream including encoded pictures; and
a scene cut artifact detector determining a scene cut artifact in the bitstream using information from the bitstream without decoding the bitstream to derive pixel information.

15. The apparatus of claim 14, wherein the decoder decodes at least one of frame sizes, prediction residuals and motion vectors for a set of pictures from the bitstream, wherein the set of pictures includes at least one of a candidate scene cut picture, a picture preceding the candidate scene cut picture, and a picture following the candidate scene cut picture, and wherein the scene cut artifact detector determines respective difference measures for the candidate scene cut picture in response to the at least one of the frame sizes, the prediction residuals, and the motion vectors and determines that the candidate scene cut picture is a picture with the scene cut artifact if one or more of the difference measures exceed their respective predetermined thresholds.

16. The apparatus of claim 15, further comprising:
a candidate scene cut artifact detector configured to perform at least one of:
selecting at least one of an intra picture as the candidate scene cut picture if compressed data for at least one block in the intra picture are lost; and
selecting a picture referring to a lost picture as the candidate scene cut picture.

17. The apparatus of claim 16, wherein the scene cut artifact detector determines that the at least one block in the candidate scene cut picture has the scene cut artifact.

18. The apparatus of claim 17, further comprising:
a quality predictor assigning a lowest quality level to the at least one block determined to have the scene cut artifact.

19. (canceled)

20. The apparatus of claim 15, wherein the candidate scene cut artifact detector determines an estimated number of transmitted packets of a picture and an average number of transmitted packets of pictures preceding the picture, and selects the picture as the candidate scene cut picture when a ratio between the estimated number of transmitted packets of the picture and the average number of transmitted packets of the pictures preceding the picture exceeds a pre-determined threshold.

21. The apparatus of claim 15, wherein the candidate scene cut artifact detector determines an estimated number of transmitted bytes of a picture and an average number of transmitted bytes of pictures preceding the picture, and selects the picture as the candidate scene cut picture when a ratio between the estimated number of transmitted bytes of the picture and the average number of transmitted bytes of the pictures preceding the picture exceeds a pre-determined threshold.

22. The apparatus of claim 21, wherein the candidate scene cut artifact detector determines the estimated number of transmitted bytes of the picture in response to a number of received bytes of the picture and an estimated number of lost bytes.

23. The apparatus of claim 15, wherein the scene cut artifact detector determines that a block in the candidate scene cut picture has the scene cut artifact when the block refers to the lost picture.

24. (canceled)

25. A processor readable medium having stored thereupon instructions for causing one or more processors to collectively perform:
accessing a bitstream including encoded pictures; and
determining a scene cut artifact in the bitstream using information from the bitstream without decoding the bitstream to derive pixel information.
